(19) United States
(12) Patent Application Publication
(10) Pub. No.: US 2017/0201636 A1
(43) Pub. Date: Jul. 13, 2017

(54) INFORMATION PROCESSING SYSTEM

(71) Applicant: FUJI XEROX CO., LTD., Tokyo (JP)

(72) Inventors: Hiromoto ANDO, Kanagawa (JP); Yoshimi UEZU, Kanagawa (JP); Chie OHARA, Kanagawa (JP); Masayuki KONO, Kanagawa (JP)

(73) Assignee: FUJI XEROX CO., LTD., Tokyo (JP)

(21) Appl. No.: 15/209,097

(22) Filed: Jul. 13, 2016

(30) Foreign Application Priority Data
Jan. 8, 2016 (JP) 2016-002747

(51) Int. Cl. H04N 1/00; H04N 1/32

(52) U.S. Cl. CPC H04N 1/00344; H04N 1/00413; H04N 1/32539; H04N 1/32625

(57) ABSTRACT

An information processing system includes at least one information processor constituting a group and a management apparatus that manages a help information group. The information processor includes a periodical notifier that periodically notifies the management apparatus of management information, a memory that stores help information provided from the management apparatus, and a presenting unit. If requested help information does not exist in the memory but exists in a second information processor included in the group, the presenting unit acquires the help information from the second information processor and presents it. If the help information does not exist in any information processor within the group, the presenting unit acquires the help information from the management apparatus and presents it. The management apparatus includes a help controller that performs control for providing the help information, determined to be a target to be provided based on the management information, to the information processor.

### CROSS-REFERENCE TO RELATED APPLICATIONS

This application is based on and claims priority under 35 USC 119 from Japanese Patent Application No. 2016-002747 filed Jan. 8, 2016.

### BACKGROUND

### Technical Field

The present invention relates to information processing systems.

### SUMMARY

According to an aspect of the invention, there is provided an information processing system including at least one information processing apparatus that constitutes a group and a management apparatus that manages a help information group to be provided to the information processing apparatus. The information processing apparatus includes a periodical notifier, a memory, and a presenting unit. The periodical notifier periodically notifies the management apparatus of management information indicating a status of the information processing apparatus. The memory stores help information provided from the management apparatus. If help information requested from a user does not exist in the memory of the information processing apparatus but exists in a second information processing apparatus included in the group to which the information processing apparatus belongs, the presenting unit acquires the help information from the second information processing apparatus and presents the help information. If the help information does not exist in any information processing apparatus within the group, the presenting unit acquires the help information from the management apparatus and presents the help information. The management apparatus includes a help controller that performs control for providing the help information, which is determined to be a target to be provided based on the management information notified from the periodical notifier of the information processing apparatus, to the information processing apparatus.

### BRIEF DESCRIPTION OF THE DRAWINGS

An exemplary embodiment of the present invention will be described in detail based on the following figures, wherein:

FIG. 1 illustrates an example of the configuration of a system according to an exemplary embodiment;

FIG. 2 illustrates an example of the configuration of a management apparatus;

FIG. 3 illustrates an example of group management information stored in the management apparatus;

FIG. 4 illustrates an example of help management information stored in the management apparatus;

FIG. 5 illustrates an example of the configuration of each image forming apparatus;

FIG. 6 illustrates an example of group information stored in each image forming apparatus;

FIG. 7 illustrates an example of help management information stored in each image forming apparatus;

FIG. 8 illustrates an example of a process performed by an image forming apparatus that has received a command from a user for displaying a help item;

FIG. 9 illustrates an example of a process performed by an image forming apparatus when a periodical-notification and help-update timing is reached;

FIG. 10 illustrates an example of a process performed by the management apparatus when receiving periodical notification from an image forming apparatus; and

FIG. 11 illustrates an example of a detailed process in step S50 in FIG. 10.

### DETAILED DESCRIPTION

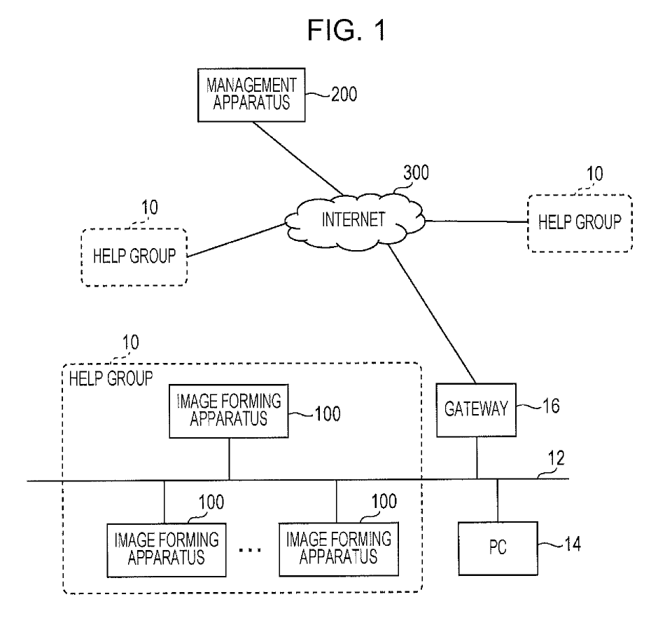

The configuration of a system according to an exemplary embodiment of the present invention will now be described with reference to FIG. 1. As shown in FIG. 1, the system according to this exemplary embodiment includes one or more help groups 10 connected to the Internet 300 and also includes a management apparatus 200.

Each help group 10 is constituted of multiple image forming apparatuses 100 that are capable of using the same help information. The expression “capable of using help information” with respect to a certain image forming apparatus 100 implies that the help information is suitable with respect to the image forming apparatus 100. The help information of each image forming apparatus 100 includes many descriptions (individual help descriptions will be referred to as “help items” hereinafter), such as a description explaining how to use an individual function of the image forming apparatus 100 and a description explaining how to deal with various possible errors (failures). The expression “the multiple image forming apparatuses 100 are capable of using the same help information” normally corresponds to, but not limited to, a case where the multiple image forming apparatuses 100 are all capable of using all of the multiple help items (e.g., the multiple image forming apparatuses 100 are of the same model or system). For example, the concept of the expression “the multiple image forming apparatuses 100 are capable of using the same help information” also includes a case where each help group 10 is constituted of three image forming apparatuses 100 of A, B, and C, the image forming apparatuses A and B are capable of using help items a and b, and the image forming apparatuses B and C are capable of using help items b and c.

Multiple image forming apparatuses 100 belonging to one help group 10 are connected to the same local network 12, such as a local area network or an intranet, and are communicable with each other. A user inputs a print command to an image forming apparatus 100 from a personal computer (PC) 14 via the local network 12. The local network 12 is connected to the Internet 300 via a gateway 16, such as a firewall. Furthermore, an image forming apparatus 100 not belonging to the help group 10 may also exist in the local network 12.

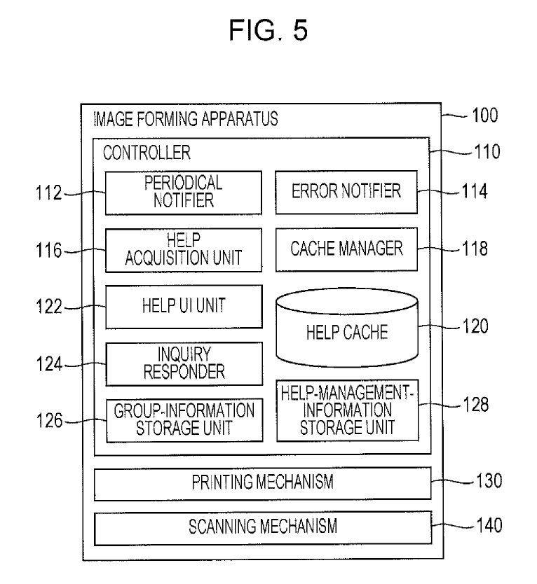

Each image forming apparatus 100 is, for example, a printer, a scanner, a copier, a facsimile apparatus, or a multifunction apparatus equipped with one or more of these functions. As shown in FIG. 5, each image forming apparatus 100 includes a printing mechanism 130 for printing and a scanning mechanism 140 for optically reading a document, and performs processes, such as printing, scanning, and copying, by using these mechanisms. However, this is merely an example, and the technique according to this exemplary embodiment is applicable to an image forming apparatus having a single function, such as a printing function alone or a scanning function alone. Each image forming apparatus 100 is connected to the Internet 300 via the gateway 16 or, for example, a portable telephone network.

The management apparatus 200 provides help information to each image forming apparatus 100. The help information may be provided based on a push method in which the management apparatus 200 actively provides the help information even if there is no request from an image forming apparatus 100, or based on a pull method in which the management apparatus 200 provides the help information in response to a request from an image forming apparatus 100, such as a hypertext transfer protocol (HTTP) request. A method suitable for the environment, such as the network, in which the image forming apparatuses 100 are installed may be used. For example, the management apparatus 200 acquires, from each image forming apparatus 100, management information indicating, for example, the usage status of the image forming apparatus 100 or the usage state of help information and information related to an error occurring in the image forming apparatus 100. In accordance with the acquired information, the management apparatus 200 identifies help information with a high possibility of being beneficial for the image forming apparatus 100 and provides the identified help information to the image forming apparatus 100. Information, such as the management information and the error information of the image forming apparatus 100, used by the management apparatus 200 for identifying the help information to be provided has many similarities with information acquired from the image forming apparatus 100 by a server for remote maintenance. Thus, the server that performs remote maintenance may additionally have the function of the management apparatus 200 according to this exemplary embodiment that provides help information.

The management apparatus 200 and the image forming apparatuses 100 will be described below in further detail.

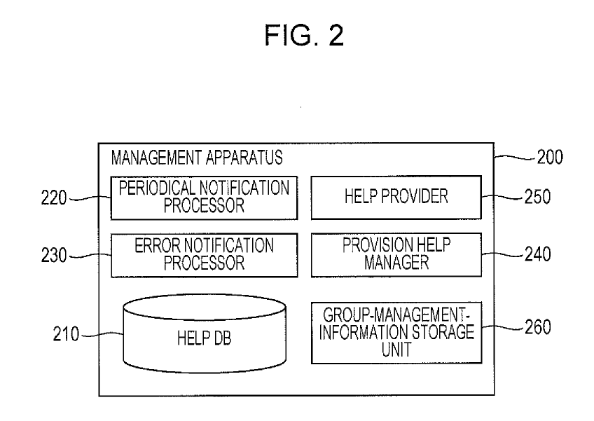

As shown in FIG. 2, the management apparatus 200 has a help database (DB) 210, a periodical notification processor 220, an error notification processor 230, a provision help manager 240, a help provider 250, and a group-management-information storage unit 260.

The help DB 210 is a database that stores help information. A large number of help items are stored in the help DB 210. Each help item includes a help ID for uniquely identifying the item and help contents of help information with respect to the item. The help contents are the contents of a help description corresponding to the topic of the relevant help item and include, for example, a description of an operation method for a specific operation of an image forming apparatus 100 or a description of a method for dealing with a specific error.

Furthermore, the help DB 210 may contain list-of-help-contents information indicating the list of contents of a help item group usable by each help group 10 and search index information used for searching for individual help items. Each heading included in the list of contents is linked to the help item corresponding to the heading. Thus, by selecting a heading, the corresponding help item is accessible. By using the search index information, a help item corresponding to a search word input by a user is retrievable. In a case where the management apparatus 200 corresponds to multiple models of image forming apparatuses 100, the help DB 210 stores, for each model, list-of-help-contents information and a help item group corresponding to the model.

The periodical notification processor 220 processes management information of each image forming apparatus 100 periodically notified by a periodical notifier 112 of the image forming apparatus 100 so as to determine a help item group of high necessity for the image forming apparatus 100 at the time of the notification. Based on the acquired management information, the periodical notification processor 220 may have a function of determining a help item of low necessity for the image forming apparatus 100 from among the help items stored in the image forming apparatus 100.

For example, based on information about help items stored in an image forming apparatus 100 and information about the number of times the help items are referred to, which are included in management information from the image forming apparatus 100, the periodical notification processor 220 may identify a help item of high necessity or a help item of low necessity for that image forming apparatus 100. For example, if it is determined from the management information received from the image forming apparatus 100 that help information with a high priority level (e.g., a priority level higher than or equal to a certain threshold value) is not stored in that image forming apparatus 100, it is determined that the help information is of high necessity for that image forming apparatus 100. Moreover, for example, a help item not frequently referred to from among the help items stored in the image forming apparatus 100 (e.g., a help item whose number of times referred is smaller than or equal to a preset threshold value regardless of the fact that a predetermined period has elapsed since the help item is acquired by the image forming apparatus 100) is determined as being of low necessity for that image forming apparatus 100.

The periodical notification processor 220 may determine an event, such as an error that may occur in the image forming apparatus 100 in the near future with a high possibility, in accordance with each item value of the notified management information and may determine a help item that may be necessary for the image forming apparatus 100 based on the determination result. This determination may be performed by using a related-art technique of predicting the occurrence of an event, such as an error in the image forming apparatus 100. Examples of such an event include an occurrence of a toner shortage, an occurrence of a paper jam, and a replacement timing of a photoconductor drum. The periodical notification processor 220 may use such a prediction determination technique to determine an event that may occur with a high possibility. This determination may be performed in view of not only the currently notified management information but also management information notified in the past. Then, the periodical notification processor 220 may determine a help item corresponding to each event determined that it may occur in the image forming apparatus 100 in the near future with a high possibility as a help item of high necessity for the image forming apparatus 100 at the current time point. The correspondence relationship between the events and the help items are registered in advance in a database within the management apparatus 200, and the periodical notification processor 220 refers to this database to identify a help item corresponding to each event determined that it may occur in the near future with a high possibility.

Then, the periodical notification processor 220 registers, in the provision help manager 240, a help-item addition command including the data of a help item group determined as being of high necessity for the image forming apparatus 100 and a help-item deletion command including information (e.g., help IDs of help items) for identifying a help item group stored in that image forming apparatus 100 but determined as being of low necessity therefor in association with identification information (referred to as “apparatus ID”) of that image forming apparatus 100. The registered information serves as upcoming update information related to the help information stored (cached) in that image forming apparatus 100. The process for generating and registering this update information is performed for each of the image forming apparatuses 100.

Based on error information notified from an error notifier 114 of the image forming apparatus 100, the error notification processor 230 identifies a help item indicating a method for dealing with an error indicated by the error information. Then, the data of the identified help item is associated with the apparatus ID of the image forming apparatus 100 and is registered in the provision help manager 240.

The provision help manager 240 is a functional module that manages update information of help items to be provided to each image forming apparatus 100. The provision help manager 240 stores the update information generated by the periodical notification processor 220 for an image forming apparatus 100 and the data of a help item identified by the error notification processor 230 for that image forming apparatus 100 in association with the apparatus ID of that image forming apparatus 100.

The help provider 250 receives a help acquisition request from a help acquisition unit 116 of an image forming apparatus 100 and transmits a help item to the image forming apparatus 100 in response to the request. First, as one example, when the help provider 250 receives a help acquisition request that designates a help ID to be desirably acquired, the help provider 250 reads the help item corresponding to the help ID from the help DB 210 and replies to the image forming apparatus 100. Furthermore, if an update-information acquisition request is received from an image forming apparatus 100, the help provider 250 provides, to that image forming apparatus 100, the update information stored in the provision help manager 240 in association with the apparatus ID of that image forming apparatus 100. The update information includes, for example, the data of a help item to be additionally stored in that image forming apparatus 100 and a deletion command for a help item within that image forming apparatus 100. If the transmission of the update information to the image forming apparatus 100 is successful, the help provider 250 deletes that update information from the provision help manager 240. Furthermore, in a case where there is a help acquisition request from an image forming apparatus 100, if the data of a help item desired by the error notification processor 230 is registered in the provision help manager 240 in association with the apparatus ID of that image forming apparatus 100, the help provider 250 responds by sending that help item to that image forming apparatus 100.

Although not shown in the drawings, the management apparatus 200 has a user interface (UI) function for an operator (human) who responds to inquiries from users of the image forming apparatuses 100 by, for example, telephone or chatting. This UI function is provided to the operator via a display device attached to the management apparatus 200 or via a computer on a network accessible to the management apparatus 200. The operator responds to an inquiry from each user and uses the UI function so as to register a help item useful for the inquiry in the provision help manager 240 in association with the apparatus ID of the relevant image forming apparatus 100. The registered help item is to be transmitted to that image forming apparatus 100 by the help provider 250 when a help acquisition request arrives from the image forming apparatus 100.

Furthermore, when a new function is added to each image forming apparatus 100 as a result of, for example, a version upgrade of software that controls the image forming apparatus 100, a help item with respect to the function is added to the help DB 210. Then, the list-of-help-contents information and the search index information corresponding to the image forming apparatus 100 are updated to new versions in which the added help item is reflected. In a case where such updating is performed, the updated list-of-help-contents information and the updated search index information are registered in the provision help manager 240 in association with the apparatus ID of each image forming apparatus 100 of the relevant model. Subsequently, when a help acquisition request arrives from an image forming apparatus 100, if list-of-help-contents information is registered in association with the apparatus ID of that image forming apparatus 100, for example, the registered list-of-help-contents information is transmitted to the image forming apparatus 100.

The group-management-information storage unit 260 stores management information of each help group 10. The management information stored in the group-management-information storage unit 260 includes group management information and help management information.

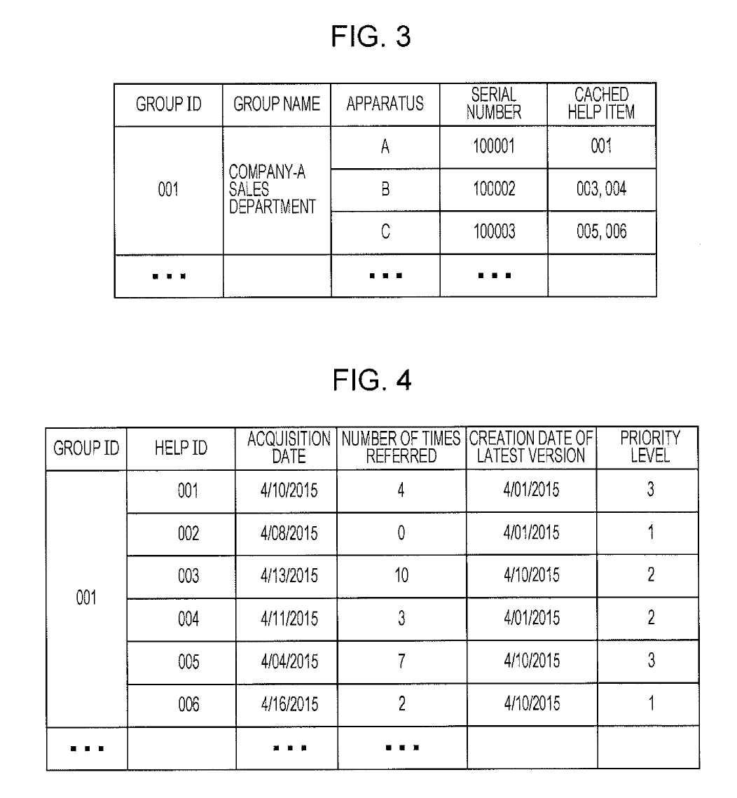

FIG. 3 illustrates an example of the group management information. In this example, the group management information includes, for each help group 10, the name (“group name”) of the help group 10, the apparatus name (“apparatus”) and the serial number of each image forming apparatus 100 belonging to that help group 10, and an ID list of help items stored (cached) in the relevant image forming apparatus 100 in association with a group ID, which is unique identification information for that help group 10. A serial number is a unique consecutive number given to each image forming apparatus 100 by the manufacturer and is used as identification information of that image forming apparatus 100.

FIG. 4 illustrates an example of the help management information stored in the group-management-information storage unit 260. The help management information shown includes information about individual help items stored (cached) in image forming apparatuses 100 within a help group 10 in association with a group ID of the help group 10. The information about each of these help items includes, for example, the help ID of that help item, the acquisition date on which that help item is acquired from the management apparatus 200 by (any of the image forming apparatuses 100 within) that help group 10 (the acquisition date may be accompanied by the version information of that help item), the number of times that help item is referred to within that help group 10, the creation date of the latest version of that help item, and the priority level of that help item. A priority level of a help item is assigned by, for example, a manager managing the help information in accordance with the degree of importance of the help item. In the example shown in FIG. 4, the degree of importance of a help item increases with decreasing value of the priority level. For example, a help item with a help ID “002” having a priority level of “1” is a help item of greater importance with higher priority over a help item with a help ID “001” having a priority level of “3”.

Next, the image forming apparatuses 100 will be described in detail.

As shown in FIG. 5, each image forming apparatus 100 has a controller 110, a printing mechanism 130, and a scanning mechanism 140.

The printing mechanism 130 is a mechanical mechanism for printing an image onto a medium by using ink or toner. The scanning mechanism 140 generates an electrical image signal by optically reading a document.

The controller 110 is an information processing device that controls the image forming apparatus 100. Although the controller 110 has various types of functions for controlling the printing mechanism 130 and the scanning mechanism 140 and for performing, for example, a UI (user interface) process using an input-output device, such as a touchscreen, functions related to the management of help information (i.e., the periodical notifier 112 to a help-management-information storage unit 128) are specifically illustrated in FIG. 5.

The periodical notifier 112 notifies the management apparatus 200 of management information of the image forming apparatus 100 on a periodical basis, such as once a day or once a week. The notified management information is used for managing the image forming apparatus 100 and indicates, for example, the usage status of the image forming apparatus 100. The management information is a group of one or more information items indicating, for example, the past usage history or the current status of the image forming apparatus 100 or consumables (such as a toner cartridge) or replacement parts (such as a photoconductor drum) attached to the image forming apparatus 100. The management information includes items, such as billing meter information (e.g., a counter value indicating the number of printed sheets for each of a monochrome item and a color item), operation counter information for each service, consumables information (e.g., the remaining amount of toner), usage frequency information of periodical replacement parts (e.g., the usage amount of a photoconductor drum), failure history information, and operational information of the printing mechanism 130. These information items may be items similar to notification information that the image forming apparatus 100 periodically provides to a maintenance center for remote maintenance. Furthermore, the management information that the periodical notifier 112 notifies of the management apparatus 200 may include the help management information stored in the help-management-information storage unit 128, which will be described later, and information about an available space in a help cache 120. The help management information, which will be described in detail later, includes, for example, information about the help IDs, the acquisition dates, and the number of times referred with respect to help items stored in the relevant image forming apparatus 100.

The error notifier 114 notifies the management apparatus 200 of information (error information) related to an error that has occurred in the image forming apparatus 100. This error information includes, for example, an error code for uniquely identifying the type of error that has occurred. Moreover, the error information may also include further detailed information about the contents of the error. The error information to be transmitted to the management apparatus 200 by the error notifier 114 may be similar to the error notification information that the image forming apparatus 100 provides to the maintenance center for remote maintenance. The notification of the error information to the management apparatus 200 from the error notifier 114 may be performed automatically when the error occurs or may be performed when an acquisition command for help information with respect to the occurred error is received from the user.

The help acquisition unit 116 acquires a help item from, for example, the management apparatus 200. Operation modes of the help acquisition unit 116 include an individual acquisition mode in which a help item explicitly designated by the user is acquired, a periodical mode in which a help item is periodically acquired when there is no error occurring in the image forming apparatus 100, and an error mode corresponding to when an error occurs.

In the individual acquisition mode, for example, a help item selected by the user from a list of help contents or a search result is acquired from the management apparatus 200. However, with regard to a help item stored in the help cache 120 in the relevant image forming apparatus 100 or in the help cache 120 in another image forming apparatus 100 within the same help group 10, the help item is not acquired from the management apparatus 200. Instead, the help item in one of the help caches 120 is used.

In the periodical mode, the help acquisition unit 116 acquires help item information desired by the management apparatus 200 in accordance with periodical notification from the periodical notifier 112. The help acquisition process in the periodical mode is performed with the same frequency as, for example, the notification from the periodical notifier 112. In one example, the help acquisition unit 116 acquires a help item from the management apparatus 200 at a timing subsequent by a predetermined time to a timing at which the periodical notifier 112 performs periodical notification. In a detailed example, the periodical notifier 112 is scheduled to provide notification to the management apparatus 200 every weekday at 9 a.m., and the help acquisition unit 116 is scheduled to acquire a help item group 15 minutes later, that is, every weekday at 9:15 a.m., by performing polling on the management apparatus 200. The time difference between the notification from the periodical notifier 112 and the corresponding help acquisition by the help acquisition unit 116 may be set in view of the time it takes for the management apparatus 200 to identify an appropriate help item for the image forming apparatus 100 based on periodically notified information.

In the error mode, the help acquisition unit 116 acquires a help item desired by the management apparatus 200 in accordance with notification of error information from the error notifier 114. When an error occurs in the image forming apparatus 100 and the error notifier 114 correspondingly notifies the management apparatus 200 of error information, the help acquisition unit 116 switches from the periodical mode to the error mode. Then, when a help item corresponding to the error in the error mode is acquired from the management apparatus 200, the error mode is canceled.

In the periodical mode, the polling interval for help information is a long interval (e.g., one day) corresponding to the notification interval of the periodical notifier 112. In contrast, in the error mode, the polling interval is set to a short interval, such as every minute, so as to acquire the help item corresponding to the error information as quickly as possible.

The help item acquired by the help acquisition unit 116 is transmitted to a cache manager 118. Furthermore, if the acquired help item corresponds to a command from a help UI unit 122, the help item is also transmitted to the help UI unit 122.

The cache manager 118 manages the help cache 120. More specifically, the cache manager 118 performs a process for storing the help item acquired by the help acquisition unit 116 into the help cache 120 as well as a process for deleting a help item from the help cache 120 for increasing the available space.

The help cache 120 is a memory that stores help items. The help cache 120 stores therein, for example, a help item group acquired from, for example, the management apparatus 200, list-of-help-contents information, and search index information.

The help UI unit 122 performs a UI process for displaying or printing help information for the user. For example, the help UI unit 122 displays the list-of-help-contents information on a screen of the image forming apparatus 100. When the user selects the heading of an item of which the user desires to see detailed information from the displayed list of contents, the help UI unit 122 searches for the help item corresponding to the selected heading from the help cache 120. When the target help item is found in the help cache 120, for example, the help contents of the help item are displayed on the screen. If the target help item is not found, an inquiry is made to determine whether that help item is stored in another image forming apparatus 100 within the same help group 10. If an image forming apparatus 100 storing that help item exists within that help group 10, the help item is provided to the image forming apparatus 100 serving as the request source in response to the inquiry. The help UI unit 122 acquiring the provided help item displays that help item on the screen. In response to a command from the user, the help UI unit 122 may print and output the help contents instead of or in addition to displaying the help contents on the screen.

In a case where an error occurs in the image forming apparatus 100, the help UI unit 122 displays a help item related to the error on the screen. If a help item corresponding to an error code of the occurred error exists in the help cache 120, the help UI unit 122 displays the help item. In a case where the help code does not exist in the help cache 120, the help item is first acquired from any of the image forming apparatuses 100 in the help group 10 and is displayed if the relevant help item exists in that image forming apparatus 100, similarly to the above-described case where a help item corresponding to a command from the user is displayed. If the help item does not exist in any of the image forming apparatuses 100, the help item corresponding to the error code is acquired from the management apparatus 200 and is displayed. This display may be performed automatically without user confirmation or may be performed when there is a reply indicating that the display is to be performed after inquiring the user about whether or not the display is to be performed.

An inquiry responder 124 responds to help-item inquiries from other image forming apparatuses 100 in the same help group 10. In this response, if an inquired help item exists in the help cache 120 of the relevant image forming apparatus 100, the help item is provided.

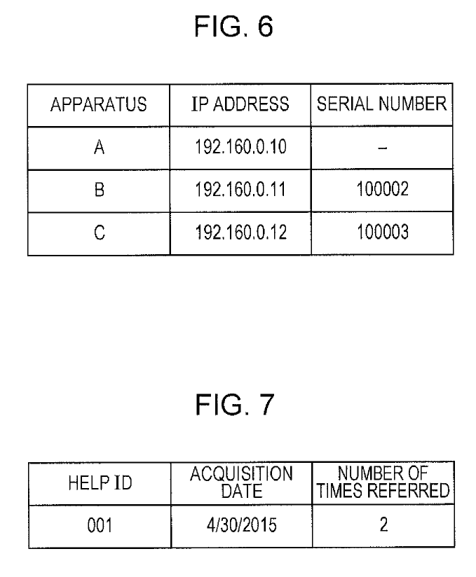

The group-information storage unit 126 stores group information to be referred to when communicating with another image forming apparatus 100 within the help group 10. FIG. 6 illustrates an example of the group information. In the example in FIG. 6, the group information includes, for each image forming apparatus 100 belonging to the relevant help group 10, an apparatus name (“apparatus”), an IP address, and a serial number of the image forming apparatus 100. The apparatus name and the serial number are similar to those described with reference to FIG. 3. An IP address is to be used when communicating via the local network 12 and may be a private address.

Every time each image forming apparatus 100 stores a new help item into the help cache 120 or deletes a help item from the help cache 120 to avoid a shortage of space in the help cache 120, the image forming apparatus 100 may notify the management apparatus 200 of the help ID of the relevant help item. In this case, in accordance with the notification, the management apparatus 200 updates the “cached help item” list of the relevant image forming apparatus 100 in the group management information (see FIG. 3) stored in the group-management-information storage unit 260.

The help-management-information storage unit 128 stores management information of each help item stored in the help cache 120. FIG. 7 illustrates an example of the management information stored in the help-management-information storage unit 128. The help management information in this example includes, for each help item stored in the help cache 120, the help ID of the help item, the acquisition date, and the number of times referred. The acquisition date indicates the date on which the relevant image forming apparatus 100 has acquired and cached the help item. The version of that help item may be identified from the acquisition date. In this example, it is assumed that the help information has its description contents updated for each help item and that the version is managed for each help item. The version information of that help item may be stored in place of or in addition to the acquisition date. The number of times referred indicates the number of times the user has referred to the help item. In a case where it is assumed that multiple image forming apparatuses 100 within a help group 10 redundantly stores the same help item, the number of times referred may be limited to the number of times the help item is referred to in the relevant image forming apparatus 100. Furthermore, for example, in order to perform control so that multiple image forming apparatuses 100 within a help group 10 do not redundantly store the same help item for saving storage space, the number-of-times-referred value stored in the help-management-information storage unit 128 is the total number of times referred within the help group 10. For example, the acquisition date and the number of times referred are to be used for determining a help item to be deleted from the help cache 120 when there is not enough available space in the help cache 120. A help item to be deleted may be selected by using a known cache algorithm, such as least recently used (LRU). Furthermore, this help management information is notified to the management apparatus 200 when performing, for example, periodical notification.

In the above example, the management apparatus 200 is notified of the help management information in the help-management-information storage unit 128 when the periodical notifier 112 performs periodical notification. Alternatively or additionally, the management apparatus 200 may be notified of the help management information when there is a change in the help management information. For example, because the help management information changes when the number of times a help item is referred to is increased as a result of the user referring to that help item, when a help item within the help cache 120 is deleted, or when a help item acquired from another image forming apparatus 100 within the same help group 10 is stored into the help cache 120, the management apparatus 200 is notified of the changed help management information in such a case.

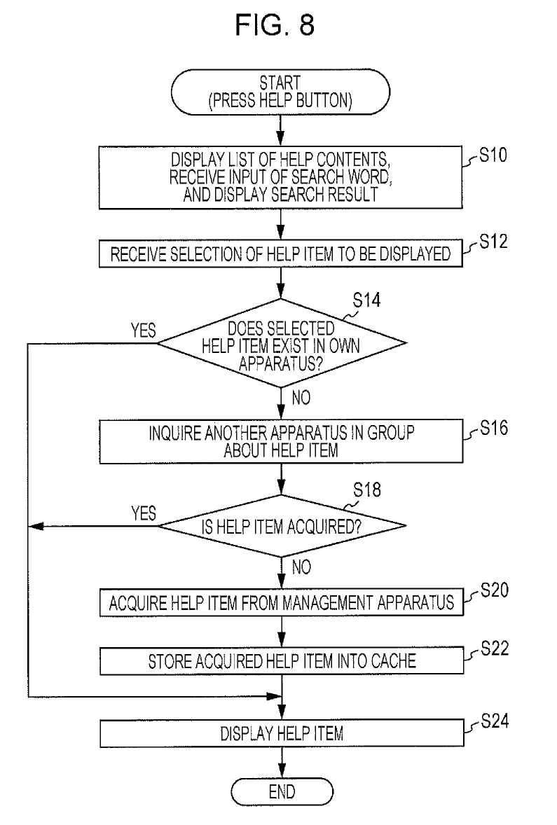

Next, a process performed by the help UI unit 122 and the help acquisition unit 116 of each image forming apparatus 100 in the individual acquisition mode will be described with reference to FIG. 8.

This process commences when the user presses a help button in an operable section (e.g., a UI screen displayed on a touchscreen) of the image forming apparatus 100. In this case, the help UI unit 122 first displays a list of help contents on a screen in step S10. In the list of help contents, for example, the headings of respective help items are listed in a predetermined order, and each heading has help ID information embedded therein. In the list of help contents to be displayed, for example, the heading of a help item group cached in any of the image forming apparatuses 100 within the help group 10 may have a title, such as “frequently-referred help”. This list-of-help-contents information is generated by the management apparatus 200 and is provided to each image forming apparatus 100.

In addition to the list of help contents described above, the help UI unit 122 may display an input section for search words on the screen. Then, in step S10, a help item corresponding to a search word input to the input section by the user is searched by using the search index information, and the heading or headings of one or more help items obtained as a search result is/are displayed on the screen.

Subsequently, in step S12, the help UI unit 122 receives user's selection from among the list of help contents or the search results displayed on the screen. In step S14, the help UI unit 122 checks whether the selected help item (i.e., the help item corresponding to the help ID associated with the selected heading) exists in the help cache 120 of the relevant image forming apparatus 100. If the help item exists in the help cache 120 of the relevant image forming apparatus 100, the help UI unit 122 reads the help item and displays the help item on the screen in step S24.

If the help item selected by the user does not exist within the help cache 120 of the relevant image forming apparatus 100, the help UI unit 122 inquires other image forming apparatuses 100 within the help group 10 about whether that help item is cached therein in step S16. If the inquiry result indicates that there is an image forming apparatus 100 storing that help item, the help item is transmitted from that image forming apparatus 100 to the relevant image forming apparatus 100. In step S18, the help UI unit 122 determines whether or not the help item is acquired from another image forming apparatus 100 within the help group 10. If the help item is acquired, the help item is displayed on the screen in step S24.

If the help item is not acquired from any of the image forming apparatuses 100 within the help group 10 in step S18, the help item is acquired by the help acquisition unit 116 from the management apparatus 200 in step S20 and is stored into the help cache 120 in step S22. In this case, for example, the help ID and the acquisition date of that help item are registered in the help-management-information storage unit 128. Then, the help UI unit 122 displays that help item on the screen in step S24.

In this example, if the help item is acquired from another image forming apparatus 100 within the help group 10 (Yes in step S18), the help item is not cached in the relevant image forming apparatus 100. This is an example of a case where the same help item is not redundantly cached in the help group 10. With this method, the storage space related to the help information in the image forming apparatuses 100 within the help group 10 may be reduced. In this case, the image forming apparatus 100 providing the help item in response to an inquiry from another image forming apparatus 100 increments the number of times (see FIG. 7) the help item is referred to in the help-management-information storage unit 128 by 1.

As another example, a help item acquired from another image forming apparatus 100 within the help group 10 may be cached into the help cache 120 within the relevant image forming apparatus 100. In this case, the other image forming apparatus 100 and the relevant image forming apparatus 100 may redundantly store the same help item, or the help item may be deleted from the other image forming apparatus 100. In a case where the other image forming apparatus 100 and the relevant image forming apparatus 100 are to redundantly store the same help item, the relevant image forming apparatus 100 registers the management information with respect to the help item acquired from the other image forming apparatus 100 into the help-management-information storage unit 128 and increments the number of times the help item is referred to by 1 after the help item is displayed in step S24. In a case where the help item is to be deleted from the other image forming apparatus 100, the management information (see FIG. 7) with respect to that help item is also transferred from the other image forming apparatus 100 to the relevant image forming apparatus 100. Then, the relevant image forming apparatus 100 registers the management information in the help-management-information storage unit 128 and updates the number of times referred.

In the example shown in FIG. 8, if the selected help item does not exist within the relevant image forming apparatus 100, other image forming apparatuses 100 within the help group 10 are inquired about whether they have that help item in step S16. As another example, list information indicating which help items are stored in other image forming apparatuses 100 within the same help group 10 may be provided to each image forming apparatus 100 from the management apparatus 200. In this example, the image forming apparatus 100 inquires only the image forming apparatus or apparatuses 100 indicated in the list information as storing the help item so as to acquire that help item, instead of inquiring other image forming apparatuses 100 within the same help group 10 in step S16. In this example, every time the management apparatus 200 receives the help management information of the relevant image forming apparatus 100 from each image forming apparatus 100 within the help group 10 in accordance with, for example, periodical notification, the management apparatus 200 updates the aforementioned list information with respect to that help group 10 by reflecting the help management notification information thereon. Then, the updated list information is provided to each image forming apparatus 100 within that help group 10.

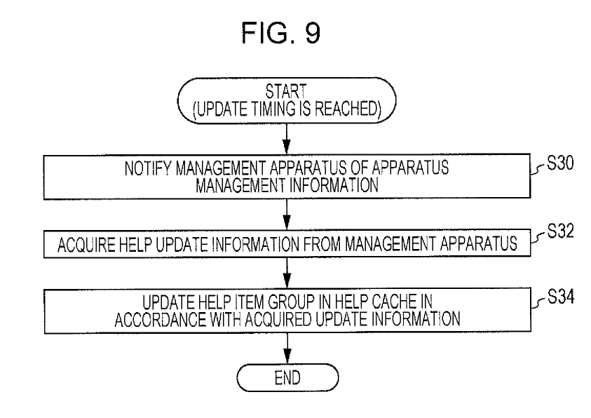

Next, an example of a process performed by the periodical notifier 112 and the help acquisition unit 116 of each image forming apparatus 100 in the periodical mode will be described with reference to FIG. 9.

In this process, when an update timing determined in accordance with a preset condition (e.g., 9 a.m. and 6 p.m. on weekdays) is reached, the periodical notifier 112 notifies the management apparatus 200 of the management information (e.g., billing meter information, operation counter information for each service, remaining-amount information of consumables, and the help management information (see FIG. 7)) of the relevant image forming apparatus 100 in step S30. Based on the management information acquired from the image forming apparatus 100, the management apparatus 200 determines a help item group of high necessity and a help item group of low necessity for that image forming apparatus 100 and generates help update information with respect to that image forming apparatus 100. For example, when a certain time period elapses after the notification in step S30, the help acquisition unit 116 accesses the management apparatus 200 so as to acquire the help update information in step S32. Then, in step S34, the help acquisition unit 116 updates the help item groups stored in the help cache 120 in accordance with the received update information. For example, in accordance with the periodical notification, a help item determined as being of high necessity is added to the help cache 120 or a help item determined as being of low necessity is deleted from the help cache 120. If the update information includes a new version for an existing help item within the help cache 120, the help item within the help cache 120 is updated to the new version. Furthermore, in step S34, the management information in the help-management-information storage unit 128 is updated in accordance with the updating of the help item groups within the help cache 120. For example, management information of a help item newly stored in the help cache 120 is registered in the help-management-information storage unit 128, and management information of a help item deleted from the help cache 120 is deleted from the help-management-information storage unit 128. Furthermore, if a help item within the help cache 120 is updated to a new version, information about the acquisition date of the relevant help item within the help-management-information storage unit 128 is changed to the date of update. Alternatively, a date-of-update item may be added to the help-management-information storage unit 128, and the date of update may be registered in this item.

The management information that the management apparatus 200 is periodically notified of from the image forming apparatus 100 may include information (which is recorded by the image forming apparatus 100 itself) about the recent usage frequency of functions in the relevant image forming apparatus 100. In accordance with the received information about the usage frequency of functions, if there is a frequently-used function (e.g., with a frequency indication value larger than a predetermined threshold value), the management apparatus 200 may add the help item related to that function to the update information as one of help items to be provided to that image forming apparatus 100 in accordance with the notification.

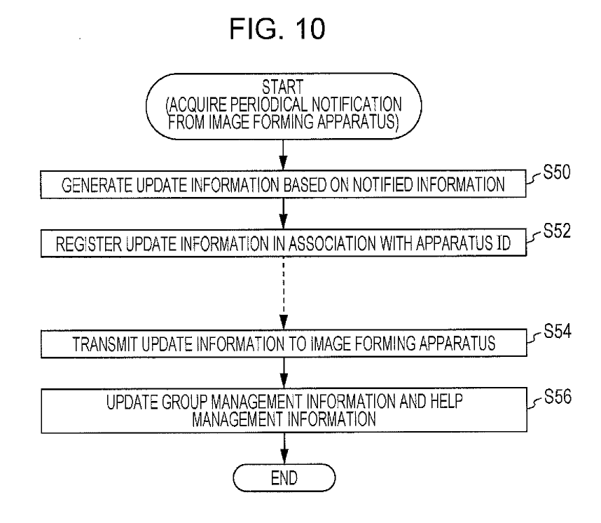

Next, an example of a process performed by the management apparatus 200 when receiving periodical notification from an image forming apparatus 100 will be described with reference to FIG. 10.

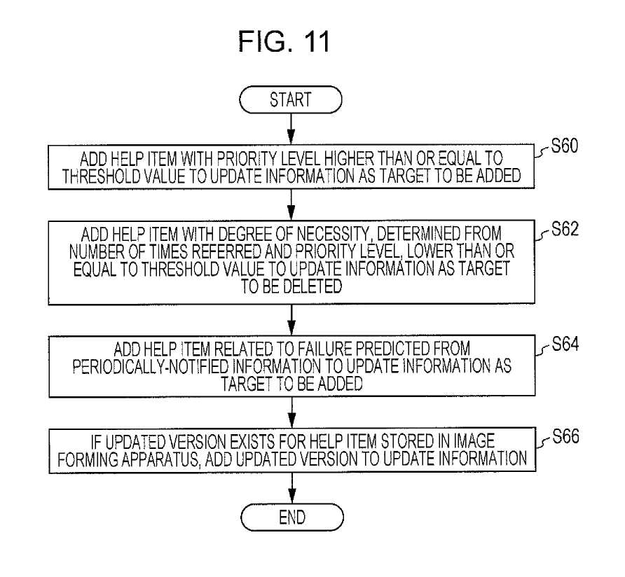

When the periodical notification processor 220 of the management apparatus 200 receives periodical notification from the periodical notifier 112 of the image forming apparatus 100, the periodical notification processor 220 generates update information with respect to a help item group in that image forming apparatus 100 in step S50 based on the information included in the periodical notification. This update information includes, for example, update data with respect to a help item to be newly stored in that image forming apparatus 100, a help item to be deleted, and a stored help item. A specific example of the process in step S50 will be described with reference to FIG. 11.

In the process in FIG. 11, the periodical notification processor 220 first identifies the help items stored in the help cache 120 of the image forming apparatus 100 based on the help management information (see FIG. 7) included in the periodical notification from that image forming apparatus 100. Then, in step S60, a help item group whose priority level is higher than or equal to the preset threshold value and that is not stored in that image forming apparatus 100 is identified from among the help items registered in the help DB 210, and the identified help item group is added to update information to be provided to that image forming apparatus 100.

If the total size of the identified help item group exceeds the available space in the help cache 120 of the image forming apparatus 100, for example, help items with low priority levels may be sequentially selected as help items to be deleted from among the help items stored in the help cache 120 so that the total volume of the selected help items to be deleted is larger than or equal to the exceeding amount. The selected help items to be deleted may be limited to help items whose priority levels are lower than or equal to the aforementioned threshold value. In step S60, a deletion command with respect to such a selected help item group to be deleted is also added to the update information.

The periodical notification processor 220 calculates an evaluation value indicating the degree of necessity of a help item from the number of times the help item is referred to, which is included in the help management information (see FIG. 7) included in the periodical notification from the image forming apparatus 100, and the priority level of that help item registered in the help DB 210. The evaluation value may be calculated by using a calculation expression in which, for example, the evaluation value increases with increasing number of times referred and the evaluation value increases with increasing priority level. Then, a help item with an evaluation value (i.e., degree of necessity) lower than or equal to a threshold value is selected as a help item to be deleted, and a command indicating that the selected help item is to be deleted is added to the update information for that image forming apparatus 100 in step S62. With regard to a help item of a certain degree of high necessity, the number of times such a help item is referred to is not large if the time elapsed since the help item is acquired is not long. Thus, the threshold-value-based determination in step S62 may be performed in view of the elapsed time by, for example, normalizing (e.g., dividing) the number of times referred by the elapsed time from the acquisition date or by increasing the threshold value as the elapsed time becomes longer.

The periodical notification processor 220 predicts a failure that may occur in the relevant image forming apparatus 100 with a high possibility from the information included in the periodical notification. If the periodical notification processor 220 predicts such a failure, a help item corresponding to the failure is added to the update information for that image forming apparatus 100 in step S64.

When adding the help item corresponding to the predictive failure to the update information, the periodical notification processor 220 may add information indicating that the help item is undeletable from the help cache 120 to the update information. When increasing the available space in the help cache 120, the cache manager 118 of the image forming apparatus 100 does not select such a help item having undeletable information added thereto as a help item to be deleted from the help cache 120. From among the help items within the help cache 120, the cache manager 118 deletes a help item that has been stored for a long time without being frequently referred to by using an algorithm, such as LRU, but does not delete a help item having undeletable information added thereto even if the help item satisfies that condition.

The periodical notification processor 220 identifies, from the help management information in the periodical notification, help items stored in the image forming apparatus 100 and the acquisition dates (or the version information) of those help items. Then, with regard to each of the identified help items, the creation date (or the version information) of the latest version of the help item is checked from the help DB 210, so that it is determined whether the help item within the image forming apparatus 100 is of an older version than the latest version within the help DB 210. If older than the latest version, the data of the latest version is added to the update information in step S66.

The order in which steps S60 to S66 are executed is not limited to the order shown in FIG. 11 and may be a freely-chosen order.

Furthermore, in steps S60 and S62, a help item to be added and a help item to be deleted with respect to the image forming apparatus 100 serving as the periodical-notification transmission source are determined from the periodical notification information and the information related to the image forming apparatus 100 within the group-management-information storage unit 260. However, this is merely an example. Alternatively, this determination may be performed by using information, in the group-management-information storage unit 260, about another image forming apparatus 100 within the same help group 10 as the relevant image forming apparatus 100.

For example, in step S60, in a case where a help item is not stored in the image forming apparatus 100 serving as the periodical-notification transmission source but has a priority level higher than or equal to the threshold value, it is determined whether or not that help item is stored in another image forming apparatus 100 within the same help group 10 based on the group management information (see FIG. 3). If the help item is stored within the same help group 10, the information about that help item is not added to the update information for that image forming apparatus 100.

As another example, in a case where it is determined that the same help item is stored in multiple image forming apparatuses 100 within the same help group 10, the management apparatus 200 may command a remaining one or more image forming apparatuses 100 excluding one image forming apparatus 100 among the multiple image forming apparatuses 100 to delete that help item. For example, with regard to each help item stored in an image forming apparatus 100 obtained from the periodical notification information from the image forming apparatus 100, the periodical notification processor 220 determines whether or not that help item is stored in another image forming apparatus 100 within the same help group 10. This determination may be performed by referring to the group management information. If it is found that the same help item is stored in another image forming apparatus 100 within the same help group 10 as a result of the determination, the periodical notification processor 220 adds a command for deleting that help item to the update information for the image forming apparatus 100 serving as the periodical-notification transmission source.

In this example, an image forming apparatus 100 that has transmitted periodical notification is caused to delete a help item redundantly stored within the help group 10. Alternatively, such a help item may be deleted by another image forming apparatus 100 within the help group 10. For example, among image forming apparatuses 100 storing the help item within the help group 10, the image forming apparatuses 100 excluding the image forming apparatus 100 corresponding to the maximum number of times the help item is referred to are caused to delete the help item. In this case, for example, a deletion command for the help item may be immediately transmitted to the corresponding image forming apparatuses 100, or a deletion command for the help item may be added to the update information for these image forming apparatuses 100 so that the help item is deleted in accordance with subsequent periodical notification from the image forming apparatuses 100. Furthermore, in this example, the group-management-information storage unit 260 records the number of times a help item is referred to for each image forming apparatus 100 within the help group 10 in place of or in addition to the total number of times the help item is referred to within the help group 10.

Furthermore, information about another image forming apparatus 100 within the help group 10 may also be used in step S64. For example, if another image forming apparatus 100 within the same help group 10 stores a help item that is the same as a help item corresponding to a predictive failure in an image forming apparatus 100 serving as a periodical notification source, the periodical notification processor 220 in one example does not add that help item to the update information for the image forming apparatus 100 serving as the periodical notification source. This is because the image forming apparatus 100 is capable of acquiring that help item from another image forming apparatus 100 within the same help group 10. In another example, the periodical notification processor 220 adds that help item to the update information for the image forming apparatus 100 serving as the periodical notification source and also commands another image forming apparatus 100 storing that help item within the same help group 10 to delete that help item. These examples are for preventing the same help item from being redundantly stored in multiple image forming apparatuses 100 within the help group 10. In a case where such redundant storage is permitted, the help item may be simply added to the update information for the image forming apparatus 100 serving as the periodical notification source.

In step S50, the group management information (see FIG. 3) and the help management information (see FIG. 4) in the group-management-information storage unit 260 are updated in addition to generating the above-described update information based on the periodical notification information received from the image forming apparatus 100. In order to perform this, the group management information in the group-management-information storage unit 260 is referred to from, for example, the apparatus serial number included in the periodical information from the image forming apparatus 100 so as to identify the help group 10 to which that image forming apparatus 100 belongs. Then, for example, since the help management information included in the periodical notification includes the ID group of the help items stored in that image forming apparatus 100 at the time of the periodical notification, the information about the “cached help item” section of the image forming apparatus 100 in the group management information is renewed to the help ID group. Furthermore, since the periodical notification information also includes information about the number of times each help item is referred to, the number of times the help item is referred to is reflected on the number of times the help item is referred to in the help management information (see FIG. 4) within the help group 10 to which the relevant image forming apparatus 100 belongs. For example, if the periodical notifier 112 of the image forming apparatus 100 is configured to provide notification of the number of times referred in a time period from the previous periodical notification to the current periodical notification, the number of times referred may be added to the number of times the relevant help item is referred to within the relevant help group 10 in step S50 in the help management information in the group-management-information storage unit 260.

Returning to the description of the process in FIG. 10, after step S50, the periodical notification processor 220 registers the generated update information in the provision help manager 240 in association with the apparatus ID of that image forming apparatus 100 in step S52.

Subsequently, the periodical notification processor 220 waits for an acquisition request for the update information from that image forming apparatus 100. When the acquisition request for the update information arrives from the image forming apparatus 100, the help provider 250 extracts the update information corresponding to the apparatus ID (i.e., the ID of that image forming apparatus 100) included in the acquisition request from the provision help manager 240 and transmits the update information to the image forming apparatus 100 in step S54.

Then, the periodical notification processor 220 updates the group management information and the help management information in the group-management-information storage unit 260 in step S56. For example, if the update information transmitted to the image forming apparatus 100 includes a help item to be added, the help ID of that help item is added to the “cached help item” section in the entry of that image forming apparatus 100 within the group management information (see FIG. 3), and the date of transmission is recorded in the “acquisition date” section corresponding to the help ID of the relevant group within the help management information (see FIG. 4). If the update information includes the help ID of a help item to be deleted, the help ID is deleted from the “cached help item” section. Furthermore, if the update information includes update data of a help item, the date in the “acquisition date” section corresponding to the help ID of the relevant group within the help management information is updated to the date of transmission.

The process performed by the periodical notification processor 220 in response to periodical notification from an image forming apparatus 100 has been described above with reference to FIGS. 5 and 6.

In the process described above, the provision help manager 240 registers the generated update information therein and waits for the image forming apparatus 100 to acquire that update information. However, this is merely an example. As another example, for example, when update information is generated based on periodical notification, the update information may be transmitted back to the image forming apparatus 100 serving as the periodical-notification transmission source.

In the above example, the management apparatus 200 provides help-item information in accordance with periodical notification from an image forming apparatus 100. Additionally, the management apparatus 200 may provide other information to that image forming apparatus 100. The information to be provided may include, for example, a file containing information for commanding changes in various kinds of settings in the image forming apparatus 100, an update file for firmware of the image forming apparatus 100, and information that a user using the image forming apparatus 100 is desirably notified of (this information is displayed on the screen of the image forming apparatus 100).

The controller 110 of each image forming apparatus 100 and the management apparatus 200 described above are realized by causing a general-purpose computer to execute programs that express processes of the functional modules of the apparatuses. In this case, the computer has, for example, a circuit configuration in which hardware units are connected via, for example, a bus. Examples of the hardware units include a microprocessor, such as a central processing unit (CPU); memory units (temporary storage units), such as a random access memory (RAM) and a read-only memory (ROM); a hard-disk-drive (HDD) controller that controls an HDD; various types of input-output (I/O) interfaces; and a network interface that performs control for connecting to a network, such as a local area network. Furthermore, this bus may be connected via, for example, an I/O interface to a disk drive for reading and/or writing information from and/or to a portable disk storage medium, such as a compact disc (CD) or a digital versatile disc (DVD), or to a memory reader-writer for reading and/or writing information from and/or to various types of standard portable nonvolatile storage media, such as a flash memory. A program having written therein the processing contents of each functional module described above is stored into a fixed storage device, such as the hard disk drive, via a storage medium, such as a CD or a DVD, or via a communication unit, such as a network, and is installed into the computer. The program stored in the fixed storage device is loaded into the RAM and is executed by the microprocessor, such as the CPU, so that each of the functional modules described above is realized.

Although the above description relates to an example with reference to the image forming apparatuses 100, the control according to this exemplary embodiment may be generally applied to information processing apparatuses having a function for presenting help information.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An information processing system comprising:
first and second information processing apparatuses that constitutes a group; and
a management apparatus that manages a help information group to be provided to the first information processing apparatus,
wherein the first information processing apparatus includes
a periodical notifier that periodically notifies the management apparatus of management information indicating a status of the first information processing apparatus,
a memory that stores help information provided from the management apparatus, and
a presenting unit, configured to search the memory of the first information processing apparatus for help information requested from a user, and to search the second information processing apparatus for the help information if the presenting unit determines that the search of the first processing apparatus memory indicates the absence of the help information in the memory of the first information processing apparatus,
wherein the presenting unit acquires the help information from the second information processing apparatus in response to a determination by the presenting unit that the search of the first processing apparatus memory indicates the absence of the help information in the memory of the first information processing apparatus and the search of the second processing apparatus indicates the presence of the help information in the second information processing apparatus, and presents the help information, and
wherein if the result of searching by the presenting unit indicates that the help information does not exist in any information processing apparatus within the group, the presenting unit acquires the help information from the management apparatus and presents the help information, and
wherein the management apparatus includes
a help controller that performs control for providing the help information, which is determined to be a target to be provided based on the management information notified from the periodical notifier of the first information processing apparatus, to the first information processing apparatus.

2. The information processing system according to claim 1,
wherein the help controller predictively detects a failure based on information included in the management information notified from the periodical notifier and determines that help information corresponding to the predictively-detected failure is the target to be provided.

3. The information processing system according to claim 1,
wherein the help controller further performs control for deleting help information, which is determined to be a target to be deleted based on the management information notified from the periodical notifier of the first information processing apparatus, from the memory of the first information processing apparatus.

4. An information processing system comprising:
at least one information processing apparatus that constitutes a group; and
a management apparatus that manages a help information group to be provided to the at least one information processing apparatus,
wherein the at least one information processing apparatus includes
a periodical notifier that periodically notifies the management apparatus of management information indicating a status of the at least one information processing apparatus,
a memory that stores help information provided from the management apparatus, and
a presenting unit,
wherein if help information requested from a user does not exist in the memory of the at least one information processing apparatus but exists in a second information processing apparatus included in the group to which the at least one information processing apparatus belongs, the presenting unit acquires the help information from the second information processing apparatus and presents the help information, and
wherein if the help information does not exist in any information processing apparatus within the group, the presenting unit acquires the help information from the management apparatus and presents the help information, and
wherein the management apparatus includes
a help controller that performs control for providing the help information, which is determined to be a target to be provided based on the management information notified from the periodical notifier of the at least one information processing apparatus, to the at least one information processing apparatus
wherein the management information includes information indicating which help information is stored in the memory of the at least one information processing apparatus, and
wherein if the help controller determines that identical help information is stored in a plurality of the information processing apparatuses within the group based on the management information notified from each information processing apparatus within the group, the help controller determines that the help information with respect to a remaining one or more information processing apparatuses excluding one information processing apparatus among the information processing apparatuses having the identical help information is a target to be deleted.
